(19) United States
(12) Patent Application Publication
(10) Pub. No.: US 2022/0014891 A1
(43) Pub. Date: Jan. 13, 2022

(54) INFORMATION PROVIDING APPARATUS, INFORMATION PROVIDING SYSTEM, AND INFORMATION PROVIDING METHOD

(71) Applicant: SHARP KABUSHIKI KAISHA, Sakai City (JP)

(72) Inventor: MITSURU KAMIYABU, Sakai City (JP)

(21) Appl. No.: 17/369,894

(22) Filed: Jul. 7, 2021

(30) Foreign Application Priority Data
Jul. 13, 2020 (JP) 2020-120012

(51) Int. Cl. H04W 4/70; H04W 4/029; H04W 4/02

(52) U.S. Cl. CPC H04W 4/70; H04W 4/025; H04W 4/029

(57) ABSTRACT

An information providing apparatus includes at least one controller, at least one storage device, and at least one communications device. The at least one controller is configured to: analyze position information, on a plurality of information terminals, stored in the at least one storage device; and obtain information on a result of the analysis, and transmits the information on the result of the analysis through the at least one communications device to at least one of the information terminals.

### CROSS-REFERENCE TO RELATED APPLICATION

The present application claims priority from Japanese Patent Application No. JP2020-120012, the content to which is hereby incorporated by reference into this application.

### BACK GROUND OF THE INVENTION

### 1. Field of the Invention

An aspect of the present invention relates to an information providing apparatus to provide information in accordance with position information on an information terminal to be used by a user, and the information terminal to output the information received from the information providing apparatus.

### 2. Description of the Related Art

How to execute processing based on position information is disclosed in techniques conventionally known in the art. An example of such techniques is an invention disclosed in Japanese Unexamined Patent Application Publication No. 2020-010318. The technique disclosed in the patent application allows a group of devices to synchronously process a visual content item and an audio content item. With this technique, the visual content item and the audio content item are divided into sub-contents, and in accordance with spatial positions of the devices, each of the sub-content items is specialized to be reproduced by one of the devices in the group. The specialized sub-content item, together with a time stamp, is transmitted to a device associated with the sub-content and the time stamp, and the transmitted sub-content item is synchronously reproduced in common among the devices in the group.

### SUMMARY OF THE INVENTION

Japanese Unexamined Patent Application Publication No. 2020-010318, however, fails to disclose a technique to provide beneficial information to a plurality of information terminals.

An aspect of the present invention is intended to provide an information providing apparatus capable of providing beneficial information to a plurality of information terminals.

In order to solve the above problem, an information providing apparatus according to an aspect of the present invention includes: at least one controller; at least one storage device; and at least one communications device. The at least one controller: analyzes position information, on a plurality of information terminals, stored in the at least one storage device; and obtains information on a result of the analysis, and transmits the information on the result of the analysis through the at least one communications device to at least one of the information terminals.

A controller according to an aspect of the present invention includes at least one storage device and at least one communications device, and controls an information providing apparatus. The controller includes: a position information analyzer analyzing position information, on a plurality of information terminals, stored in the at least one storage device; and an information obtainer obtaining information on a result of the analysis by the position information analyzer, and transmits the information on the result of the analysis through the communications device to at least one of the information terminals.

An information providing system according to an aspect of the present invention includes: a plurality of information terminals; and an information providing apparatus. Each of the information terminals transmits position information on the information terminal to the information providing apparatus. The information providing apparatus analyzes the position information on each of the information terminals, obtains information on a result of the analysis, and transmits the information on the result of the analysis to at least one of the information terminals.

An information providing method is executed by at least one of a plurality of information providing apparatus. The information providing method includes: receiving, from each of a plurality of information terminals, position information on the information terminal; analyzing the received position information on each of the information terminals; obtaining information on a result of the analysis; and transmitting the information on the result of the analysis to at least one of the information terminals.

In accordance with an aspect of the present invention, the information providing apparatus can provide beneficial information to two or more of the information terminals.

### BRIEF DESCRIPTION OF THE DRAWINGS

FIG. 1 is a block diagram illustrating a functional configuration of an information providing system including an information terminal and an information providing apparatus according to an embodiment of the present invention;

FIG. 2 is an example illustration of information on a result of analyzing position information;

FIG. 3 is a flowchart illustrating an example sequence of processing executed by an information terminal; and

FIG. 4 is a flowchart illustrating an example sequence of processing executed by an information providing apparatus.

### DETAILED DESCRIPTION OF THE INVENTION

<Configurations of Information Terminal and Information Providing Apparatus>

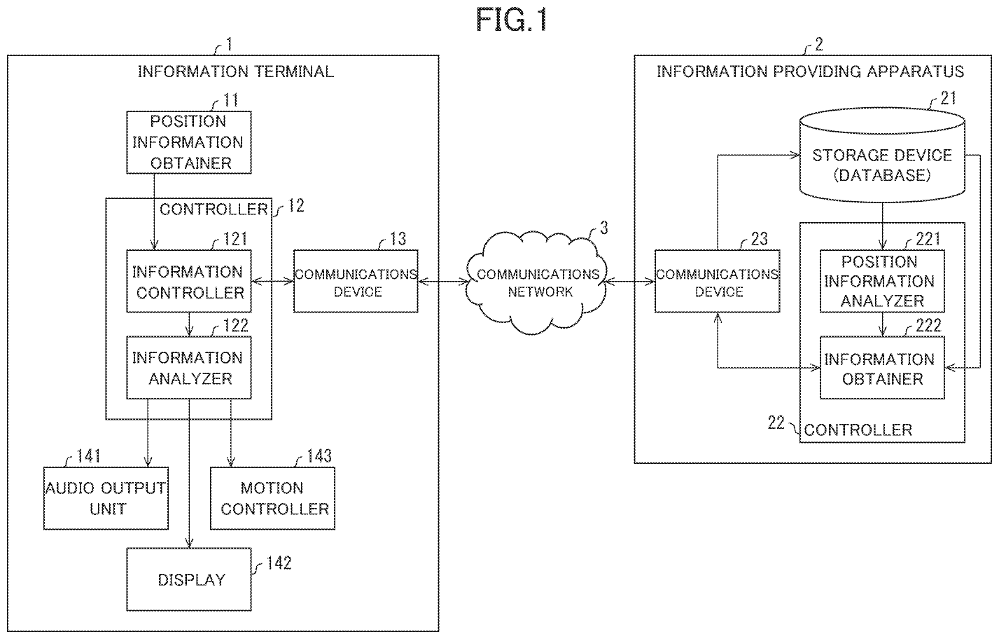

FIG. 1 is a block diagram illustrating a functional configuration of an information providing system including an information terminal 1 and an information providing apparatus 2 according to an embodiment of the present invention. The information terminal 1 basically, for example, receives and outputs audio information. Examples of the information terminal 1 include a robot-like terminal to show various motions presented by the terminal itself, and a wireless communications terminal such as a smartphone and a tablet computer.

The information terminal 1 includes: at least one position information obtainer 11; at least one controller 12; at least one communications device 13; an audio output unit 141, a display 142; and a motion controller 143. Note that the position information obtainer, the controller, and the communications device may be provided one each, or two or more of the position information obtainers, the controllers, and the communications devices may be provided.

The position information obtainer 11 detects a current position of the information terminal 1. The position information obtainer 11 may detect a position of the information terminal 1, using, for example, satellite information from such systems as a global positioning system (GPS) and a quasi-zenith satellite system (QZSS).

The controller 12 includes: an information controller 121; and an information analyzer 122. When a timing to obtain position information comes, the information controller 121 receives the position information, on the information terminal 1, obtained by the position information obtainer 11, and transmits the received position information to the information providing apparatus 2 through the communications device 13 and a communications network 3. Moreover, the information controller 121 outputs to the information analyzer 122 information received from the information providing apparatus 2 through the communications network 3 and the communications device 13. The received information indicates a result of analyzing the position information. Note that the information on the result of analyzing the position information will be described later in detail.

The information analyzer 122 analyzes the information, on the result of analyzing the position information, received from the information controller 121, and determines whether the received information is text information and image information, or motion control information. If the information on the result of analyzing the position information is audio information, the information analyzer 122 outputs the audio information to the audio output unit 141.

If the information on the result of analyzing the position information is text information and image information, the information analyzer 122 outputs the text information and the image information to the display 142. Moreover, the information analyzer 122 analyzes sentences of the text information, using such a technique as a morphological analysis. If a sentence related to a motion is found, the information analyzer 122 generates information for controlling the motion, and outputs the generated information to the motion controller 143. For example, if a sentence related to joy is found, the motion controller 143 generates information to cause the information terminal 1 to present a joyful motion. If a sentence related to sadness is found, the motion controller 143 generates information to cause the information terminal 1 to present a sad motion.

Moreover, if the information on the result of analyzing the position information is for controlling a motion, the information analyzer 122 outputs the motion-controlling information to the motion controller 143.

When receiving the audio information from the information analyzer 122, the audio output unit 141 reproduces the audio information by speech synthesis and outputs the reproduced audio information. When receiving the text information and the image information from the information analyzer 122, the display 142 displays the text information and the image information. When receiving from the information analyzer 122 the information for controlling a motion, the motion controller 143 causes the information terminal 1 to present the motion.

The communications device 13 holds wireless communications with, for example, the information providing device 2, another information terminal, and a personal computer (PC) through the communications network 3 such as the Internet. The communications device 13 transmits, to the information providing apparatus 2, the position information, on the information terminal 1, to be output from the information controller 121. Moreover, the communications device 13 receives, from the information providing apparatus 2, the information on the result of analyzing the position information, and outputs the received information to the information controller 121.

The information providing apparatus 2 includes: at least one storage device (a database) 21; at least one controller 22; and at least one communications device 23. The controller 22 includes: a position information analyzer 221; and an information obtainer 222.

The database 21 is such a storage device as a hard disc and a flash memory. The data base 21 stores position information on the information terminal 1 including a plurality of information terminals 1, information on a group to which the information terminal 1 belongs, and information on the result of analyzing the position information. For example, the database 21 may store the result of analyzing the position information in association with a format of a message base on the analysis result. This format allows the information terminal 1 to output an audio message or a text message based on the result of analyzing the position information. As a specific example, if an analysis result shows that the position indicated by the position information is within a predetermined range from a previously registered position, the analysis result may be associated with a format of a message stating, “(name of a group to which the information terminal 1 belongs) is found in (name of a position).” Moreover, if an analysis result shows that a distance between the position of an information terminal 1 and the position of another information terminal 1 is within a predetermined range, the analysis result may be associated with a format of a message stating, “(name of a group to which the information terminal 1 belongs) and (name of a group to which the other information terminal 1 belongs) are close to each other.” Such features allow each of the information terminals 1 to output a message based on, for example, a positional relationship among the information terminals 1.

Note that, in the database 21, an identification information item is previously registered for each of the information terminals 1, and the registered information terminal 1 is provided with a service. Furthermore, the registered information terminals 1 are previously organized into groups, and the database 21 also stores information that each of which registered information terminals 1 belongs to which group. Hence, the names of the groups contained in the above format can be identified, using such information.

The position information analyzer 221 obtains the position information, on the information terminals 1, stored in the database 21, and analyzes a positional relationship among the information terminals 1. As can be seen, the information terminals 1 are previously organized into groups to be managed, and registered in the database 21. When a timing comes to transmit, to an information terminal 1, information on a result of analyzing position information on the information terminal 1, the position information analyzer 221 obtains from the data base 21 position information on information terminals 1 of a group to which the information terminal 1 belongs. After that, the position information analyzer 221 analyzes the position information on the information terminals 1.

The information obtainer 222 receives a result of the analysis from the position information analyzer 221. The information obtainer 222 searches the database 21 in accordance with the analysis result to obtain information to be transmitted to the information terminal 1, and outputs the obtained information to the communications device 23.

The communications device 23 holds wireless communications with, for example, the information terminal 1 and a PC through the communications network 3 such as the Internet. The communications device 23 sequentially stores, in the database 21, the position information received from the information terminal 1. Moreover, the communications device 23 transmits to the information terminal 1 the information, obtained by the information obtainer 222, on the result of analyzing the position information. An example of this information is a message created with a combination of the above format and the name of a group identified using the above technique. The message may be either audio information or text information.

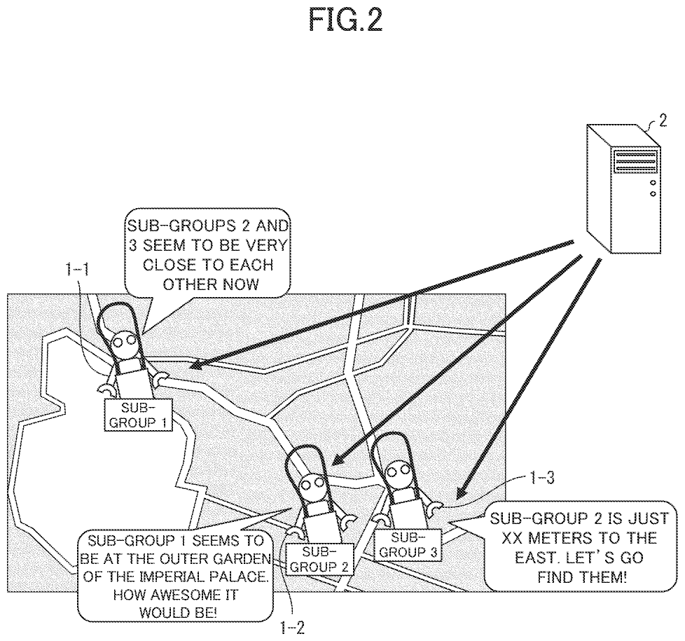

FIG. 2 is an example illustration of information on a result of analyzing position information. FIG. 2 shows a case where students on a school trip take information terminals 1 with them. One information terminal 1 is provided to each of sub-groups (Sub-Groups 1 to 3) to which a plurality of students belong. Note that the information terminals 1-1 to 1-3, taken with the students who belong to Sub-Groups 1 to 3, are previously registered in the same group.

When the position information analyzer 221 obtains position information on the information terminal 1-1 taken with the students of Sub-Group 1, on the information terminal 1-2 taken with the students of Sub-Group 2, and on the information terminal 1-3 taken with the students of Sub-Group 3, the position information analyzer 221 calculates distances between the information terminals 1-1 to 1-3. After that, the position information analyzer 221 outputs the calculated distances to the information obtainer 222.

When information obtainer 222 detects that the information terminals 1-1, 1-2, and 1-3 of Sub-Groups 1, 2, and 3 are within a range of a predetermined distance, the information obtainer 222 searches the database 21 and obtains information presenting, “Sub-Groups 2 and 3 seem to be very close to each other now (i.e. information on short distance).” After that, through the communications device 23, the information obtainer 222 transmits the information to, for example, the information terminal 1-1 of Sub-Group 1. If the information received by the information terminal 1-1 of Sub-Group 1 is audio information, the audio output unit 141 delivers the information in a form of speech by speech synthesis. Moreover, if the received information is text information and image information, the display 142 presents the position of, and the information on, the information terminals 1-1 to 1-3 on a map.

When the information obtainer 222 detects from the position information on the information terminal 1-1 of Sub-Group 1 that Sub-Group 1 is at the outer garden of the Imperial Palace, the information obtainer 222 searches the database 21 and obtains information presenting, “Sub-Group 1 seems to be at the outer garden of the Imperial Palace. How awesome it would be!” After that, through the communications device 23, the information obtainer 222 transmits the information to, for example, the information terminal 1-2 of Sub-Group 2. If the information received by the information terminal 1-2 of Sub-Group 2 is audio information, the audio output unit 141 delivers the information in a form of speech by speech synthesis. Moreover, if the received information is text information and image information, the display 142 presents the position of, and the information on, the information terminals 1-1 to 1-3 on the map.

If the information obtainer 222 detects that the information terminals 1-2 and 1-3 of Sub-Groups 2 and 3 are at a predetermined distance from each other, the information obtainer 222 searches the database 21 and obtains information presenting, “Sub-Group 2 is just XX meters to the East. Let's go find them!” After that, through the communications device 23, the information obtainer 222 transmits the information to, for example, the information terminal 1-3 of Sub-Group 3. If the information received by the information terminal 1-3 of Sub-Group 3 is audio information, the audio output unit 141 delivers the information in a form of speech by speech synthesis. Moreover, if the received information is text information and image information, the display 142 presents the position of, and the information on, the information terminals 1-1 to 1-3 on the map.

Note that if the information to be transmitted to the information terminals 1-1 to 1-3 of Sub-Groups 1 to 3 is text information and image information, the map may present, as illustrated in FIG. 2, the current positions of the information terminals 1-1 to 1-3 and all the messages in speech balloons each provided to a corresponding one of the information terminals 1-1 to 1-3. In this case, the information obtainer 222 transmits the information through the communications device 23 to all the information terminals 1-1 to 1-3 of Sub-Groups 1 to 3.

The information obtainer 222 determines, from the result of analyzing the position information, how the information terminals 1-1 to 1-3 are distributed. If, for example, only one of the information terminals 1 is greatly far away (i.e. one of the information terminals 1 is far away from the rest of the information terminals 1 at a predetermined distance or more), the information obtainer 222 may transmit text information and audio information as a caution (i.e. information on great distance) through the communications device 23 to at least one of the information terminals 1-1 to 1-3. The information obtainer 222 may search the database 21, obtain information that allows the information terminals 1 to present a motion, and transmit the information through the communications device 23 to an information terminal 1 greatly far away in order to cause the information terminal 1 to present the motion.

If the information obtainer 222 detects an information terminal that fails to transmit position information, the information obtainer 222 may transmit text information and audio information as a caution through the communications device 23 to at least one of the information terminals 1-1 to 1-3. The information obtainer 222 may search the database 21, obtain information that allows the information terminals 1 to present a motion, and transmit the information through the communications device 23 to another information terminal 1 in order to cause the other information terminal 1 to present the motion.

If the information obtainer 222 detects an information terminal 1 staying in one position (i.e., within a predetermined range) for a predetermined time period or longer, the information obtainer 222 may transmit text information and audio information as a caution through the communications device 23 to at least one of the information terminals 1-1 to 1-3. The information obtainer 222 may also search the database 21, obtain information that allows the information terminals 1 to present a motion, and transmit the information to an information terminal 1 staying in one position for a long time in order to cause the information terminal 1 to present the motion.

The position information analyzer 221 searches the database 21, obtains to analyze, for example, only several hours of the position information on each of the information terminals 1-1 to 1-3, and extracts an occupancy area (i.e. an action area) of each of the information terminals 1-1 to 1-3. After that, the information obtainer 222 may generate information to display the occupancy area of each of the information terminals 1-1 to 1-3 on the map, and transmit the generated information through the communications device 23 to at least one of the information terminals 1-1 to 1-3. If the database 21 previously stores messages based on the sizes of occupancy areas, the information terminals 1-1 to 1-3 can output a message based on a size of an occupancy area determined by analysis. The messages to be output to indicate results of comparison among occupancy areas include, for example, “Sub-Group 1 is twice as large in action area as Sub-Group 2 or more!” and “Sub-Groups 3 and 5 are alike in action area.”

The information terminals 1-1 to 1-3 may transmit their device status, such as their remaining battery levels, to the information providing apparatus 2. After that, the information obtainer 222 of the information providing apparatus 2 may organize the device status received from the information terminal 1-1 to 1-3 into such information as text information, image information, and audio information, and transmit the organized information through the communications device 23 to at least one of the information terminals 1-1 to 1-3. When the information indicating the device status is combined with a result of analyzing position information, the information terminals 1 can output a message presenting, “Low battery level. Join the closest (group name).” In such a case, the (group name) may be identified in accordance with the result of analyzing the position information.

Any one of the information terminals 1-1 to 1-3 may also function as the information providing apparatus 2, and carry out similar processing that the information providing apparatus 2 does. Such a feature eliminates the need of the information providing apparatus 2, contributing to cost reduction.

Each of the information terminals 1-1 to 1-3 may directly transmit its own position information to other information terminals 1. The display 142 of the information terminals 1-1 to 1-3 displays positions of the information terminals 1-1 to 1-3 on the map. Such a feature can reduce load on the information providing apparatus 2.

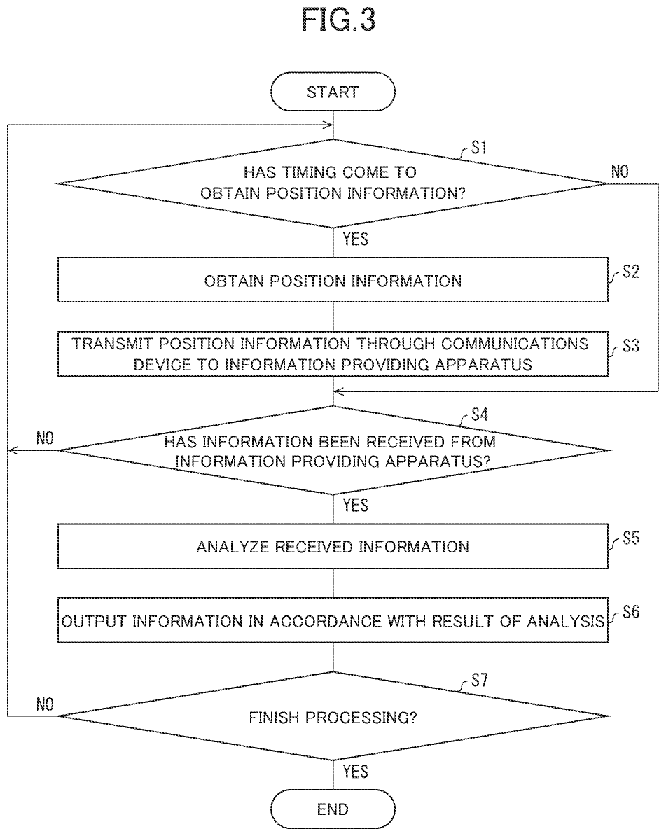

FIG. 3 is a flowchart illustrating an example sequence of processing executed by an information terminal 1. First, at Step S1, the information controller 121 determines whether a timing has come to obtain position information. For example, if the position information is obtained at regular intervals, the information controller 121 obtains the position information in the cycle of the intervals (e.g. in every several minutes).

The information controller 121 may also determine a specific operation performed on the information terminal 1, and obtain the position information with the timing of the operation. The information controller 121 may also obtain position information when the information providing apparatus 2 sends through the communications device 13 a request to transmit the position information. Note that the timing to obtain the position information is upon the reception of the request from the information providing apparatus 2 through the communications device 13.

If it is not the timing to obtain the position information (No at Step S1), the processing proceeds to Step S4. If it is the timing to obtain the position information (Yes at Step S1), the position information obtainer 11 obtains the position information on the information terminal 1 and outputs the position information to the information controller 121 (Step S2). At Step S3, the information controller 121 transmits the position information through the communications device 13 to the information providing apparatus 2.

Next, at Step S4, the information controller 121 determines whether the information controller 121 has received information, on a result of analyzing the position information, from the information providing apparatus 2 through the communications device 13. If the information controller 121 has not received the information, on the result of analyzing the position information, from the information providing apparatus 2 (No at Step S4), the processing returns to Step S1 and the subsequent processing is repeated.

If the information controller 121 has received the information on the result of analyzing the position information (Yes at Step S4), the information analyzer 122 analyses the information on the result of analyzing the position information (Step S5), and outputs the information on the result of analyzing the position information in accordance with the analysis result. As can be seen, if the information on the result of analyzing the position information is audio information, the information analyzer 122 outputs the audio information to the audio output unit 141 (Step S6).

If the information on the result of analyzing the position information is text information and image information, the information analyzer 122 outputs the text information and the image information to the display 142 (Step S6). If a sentence related to a motion is found in the text information, the information analyzer 122 generates information to cause the information terminal 1 to present the information, and outputs the generated information to the motion controller 143 (Step S6). If the information based on the result of analyzing the position information is to cause the information terminal 1 to present a motion, the information analyzer 122 outputs the information to the motion controller 143 (Step S6).

Finally, at Step S7, the controller 12 determines whether to finish the processing. If the processing is not to be finished (No at Step S7), the processing returns to Step S1, and the subsequent processing is repeated. If the processing is finished (Yes at Step S7), the processing ends.

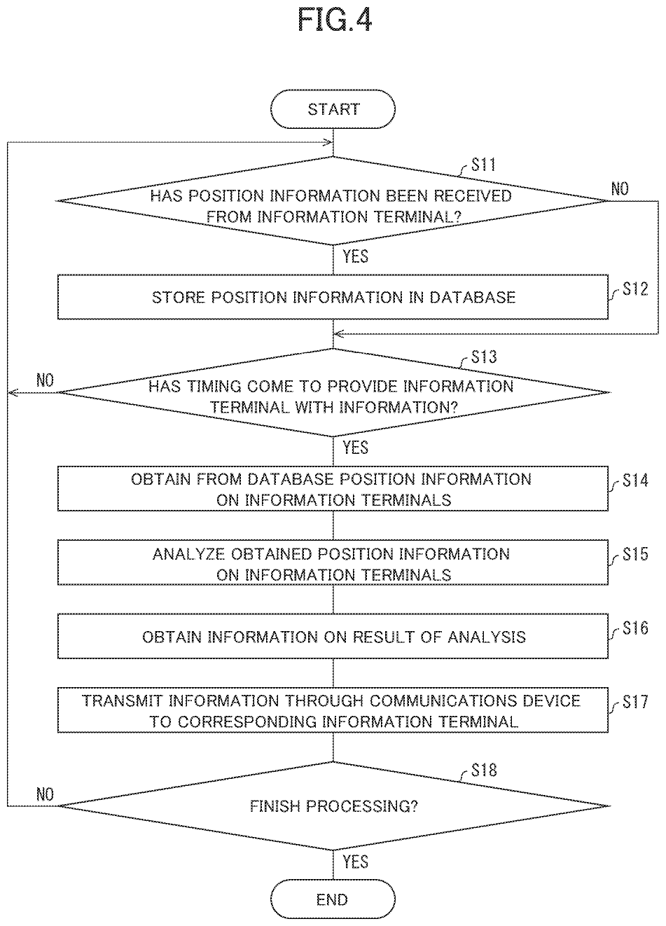

FIG. 4 is a flowchart illustrating an example sequence of processing executed by the information providing apparatus 2. First, at Step S11, the communications device 23 determines whether the communications device 23 has received position information from an information terminal 1. If the communications device 23 has not received the position information from the information terminal 1 (No at Step S11), the processing proceeds to Step S13. If the communications device 23 has received the position information from the information terminal 1 (Yes at Step S11), the communications device 23 stores the received position information in the database 21 (Step S12).

At Step S13, the position information analyzer 221 determines whether a timing has come to provide the information terminal 1 with information on a result of analyzing the position information. For example, if the information on the result of analyzing the position information is obtained at regular intervals, the position information analyzer 221 obtains the information in the cycle of the intervals (e.g. in every several minutes).

If the position information analyzer 221 obtains from the database 21 position information on a plurality of the information terminals 1 that belong to the same group, and the information terminals 1 are found to be mutually positioned in a predetermined state, the timing to provide the information terminals 1 with the information based on the result of analyzing the position information may be when, for example, (i) the distances are short between the information terminals 1, (ii) only one of the information terminals 1 is far away, (iii) the information terminals 1 are distributed out of a predetermined range, and (iv) an information terminal 1 stays still for a predetermined time period or longer.

If it is not the timing to provide the information on the result of analyzing the position information (No at Step S13), the processing returns to Step S11 and the subsequent processing is repeated. If it is the timing to provide the information on the result of analyzing the position information (Yes at Step S13), the position information analyzer 221 obtains from the database 21 the position information on the information terminals 1 that belong to the same group (Step S14). At Step S15, the position information analyzer 221 analyzes the obtained position information on the information terminals 1, and outputs a result of the analysis to the information obtainer 222.

At Step S16, the information obtainer 222 searches the database 21 in accordance with the result of analyzing the position information, and obtains the information on the result of analyzing the above position information. At Step S17, the information obtainer 222 transmits the information on the result of analyzing the position information through the communications device 23 to at least one of the information terminals 1 that belong to the same group.

Finally, at Step S18, the controller 22 determines whether to finish the processing. If the processing is not to be finished (No at Step S18), the processing returns to Step S1 and the subsequent processing is repeated. If the processing is finished (Yes at Step S18), the processing ends.

Implementation of Information Providing Apparatus 2

The controller 22 (the position information analyzer 221 and the information obtainer 222) may be implemented by logic circuits (hardware) fabricated, for example, in the form of an integrated circuit (IC chip) and may be implemented by software.

In the latter form of implementation, the information providing apparatus 2 includes a computer that executes instructions from programs or software by which various functions are implemented. This computer includes, for example, one or more processors and a computer-readable storage medium storing the above programs. The processors included in the computer then retrieve and run the programs contained in the storage medium, thereby achieving the object of an aspect of the present invention. The processors may be a central processing unit (CPU). The storage medium may be a “non-transitory, tangible medium” such as a read-only memory (ROM), a tape, a disc/disk, a card, a semiconductor memory, or programmable logic circuitry. The information providing apparatus 2 may further include a random access memory (RAM) into which the above programs are loaded. The programs may be supplied to the computer via any given transmission medium (e.g., over a communications network or by broadcasting waves) that can transmit the programs. Note that an aspect of the present invention encompasses data signals on a carrier wave that are generated during electronic transmission of the programs.

As can be seen, in the information providing apparatus 2 according to this embodiment, when detecting that the information terminals 1 are found within a range of a predetermined distance, the information obtainer 222 obtains information on the information terminals 1 within the range and transmits the information through the communications device 23 to the information terminals 1. Such a feature makes it possible to notify a user of an information terminal 1 that a user of another information terminal 1 is positioned nearby, and the users of the information terminals 1 can obtain beneficial information.

When detecting that an information terminal 1 is distant from the rest of the information terminals 1 at a predetermined distance or more, the information obtainer 222 obtains information on the distant information terminal 1 and transmit the information through the communications device 23 to the information terminals 1. Such a feature makes it possible to notify the rest of the information terminals 1 that a user of the information terminal 1 is distant, and alert the users of the information terminals 1.

When detecting that any one of the information terminals 1 fails to transmit position information, the information obtainer 222 obtains information on the transmission failure and transmits the information through the communications device 23 to the information terminals 1. Such a feature makes it possible to alert the users of the rest of the information terminals 1 when the one information terminal 1 is turned OFF and the battery level of the one information terminal 1 is low.

When detecting that any one of the information terminals 1 stays still in a predetermined range for a predetermined time period or longer, the information obtainer 222 obtains information on the stay and transmits the information through the communications device 23 to the information terminals 1. Such a feature makes it possible to alert the users of the other information terminals 1 when the user of the one information terminal 1 is involved in some kind of trouble.

The information obtainer 222 obtains information indicating an action area of each of the information terminals 1, and transmits the information through the communications device 23 to the information terminals 1. Such a feature allows a user of an information terminal 1 to understand the action area of the users of the rest of the information terminals 1, making it possible for the users of the information terminals 1 to obtain beneficial information.

Summary

An information providing apparatus according to a first aspect of the present invention includes: at least one controller; at least one storage device; and at least one communications device. The at least one controller, analyzes position information, on a plurality of information terminals, stored in the at least one storage device; and obtains information on a result of the analysis, and transmits the information on the result of the analysis through the at least one communications device to at least one of the information terminals.

The information providing apparatus obtains information on the result of analyzing the position information on the information terminals, and transmits the obtained information through the communications device to at least one of the information terminals. Such a feature makes it possible for the users of the information terminals to obtain beneficial information.

In the information providing apparatus of a second aspect of the present invention according to the first aspect, in analyzing the position information on the information terminals, the at least one controller analyzes distances between the information terminals. In obtaining the information on the result of the analysis, if any one of the information terminals is within a range of a predetermined distance, the at least one controller obtains information on the distances and transmits the information on the distances through the at least one communications device to at least one of the information terminals.

Such features make it possible to notify a user of an information terminal 1 that a user of another information terminal 1 is positioned nearby, and the users of the information terminals 1 can obtain beneficial information.

In the information providing apparatus of a third aspect of the present invention according to the first or second aspect, in analyzing the position information on the information terminals, the at least one controller analyzes distances between the information terminals. In obtaining the information on the result of the analysis, if any one of the information terminals is away from a rest of the information terminals at a predetermined distance or more, the at least one controller obtains information on the distances and transmits the information on the distances through the at least one communications device to at least one of the information terminals.

Such features make it possible to notify the users of the information terminals 1 that a user of an information terminal 1 is far away, and alert the users of the information terminals.

In the information providing apparatus of a fourth aspect of the present invention according to the first to third aspects, in analyzing the position information on the information terminals, the at least one controller analyzes an action area of each of the information terminals. In obtaining the information on the result of the analysis, the at least one controller obtains information on a result of the analysis indicating the action area of each of the information terminals, and transmits the information on the result of the analysis through the at least one communications device to at least one of the information terminals.

Such features allow a user of an information terminal to understand the action areas of the users of the rest of the information terminals, making it possible for the users of the information terminals 1 to obtain beneficial information.

In the information providing apparatus of a fifth aspect of the present invention according to the fourth aspect, in analyzing the position information on the information terminals, the at least one controller analyzes the position information, on the information terminals stored in the at least one storage device, only for a predetermined time period in order to analyze the action area of each of the information terminals.

Such a feature makes it possible to analyze the action areas of the information terminals, using only a predetermined time period of the position information on the information terminals stored in the storage device.

A controller according to a sixth aspect of the present invention includes at least one storage device and at least one communications device, and controls an information providing apparatus. The controller includes: a position information analyzer analyzing position information, on a plurality of information terminals, stored in the at least one storage device; and an information obtainer obtaining information on a result of the analysis by the position information analyzer, and transmits the information on the result of the analysis through the communications device to at least one of the information terminals.

In the controller, the information providing apparatus obtains information on the result of analyzing the position information on the information terminals, and transmits the obtained information through the communications device to at least one of the information terminals. Such features make it possible for the users of the information terminals to obtain beneficial information.

An information providing system according to a seventh aspect of the present invention includes: a plurality of information terminals; and an information providing apparatus. Each of the information terminals transmits position information on the information terminal to the information providing apparatus. The information providing apparatus analyzes the position information on each of the information terminals, obtains information on a result of the analysis, and transmits the information on the result of the analysis to at least one of the information terminals.

In the information providing system, the information providing apparatus obtains information on the result of analyzing the position information on the information terminals, and transmits the obtained information to at least one of the information terminals. Such features make it possible for the users of the information terminals to obtain beneficial information.

An information providing method according to an eighth aspect of the present invention is executed by at least one of a plurality of information providing apparatus. The information providing method includes: receiving, from each of a plurality of information terminals, position information on the information terminal; analyzing the received position information on each of the information terminals; obtaining information on a result of the analysis; and transmitting the information on the result of the analysis to at least one of the information terminals.

The method involves obtaining information on the result of analyzing the position information on the information terminals, and transmitting the obtained information to at least one of the information terminals. Such features make it possible for the users of the information terminals to obtain beneficial information.

The present invention shall not be limited to the embodiment described above, and can be modified in various manners within the scope of claims. The technical aspects disclosed in different embodiments are to be appropriately combined together to implement another embodiment. Such an embodiment shall be included within the technical scope of the present invention. Moreover, the technical aspects disclosed in each embodiment may be combined to achieve a new technical feature.

What is claimed is:

1. An information providing apparatus, comprising:
at least one controller; at least one storage device; and at least one communications device,
the at least one controller being configured to:
analyze position information, on a plurality of information terminals, stored in the at least one storage device; and
obtain information on a result of the analysis, and transmits the information on the result of the analysis through the at least one communications device to at least one of the information terminals.

2. The information providing apparatus according to claim 1, wherein
in analyzing the position information on the information terminals, the at least one controller analyzes distances between the information terminals, and
in obtaining the information on the result of the analysis, if any one of the information terminals is within a range of a predetermined distance, the at least one controller obtains information on the distances and transmits the information on the distances through the at least one communications device to at least one of the information terminals.

3. The information providing apparatus according to claim 1, wherein
in analyzing the position information on the information terminals, the at least one controller analyzes distances between the information terminals, and
in obtaining the information on the result of the analysis, if any one of the information terminals is far away from a rest of the information terminals at a predetermined distance or more, the at least one controller obtains information on the distances and transmits the information on the distances through the at least one communications device to at least one of the information terminals.

4. The information providing apparatus according to claim 1, wherein
in analyzing the position information on the information terminals, the at least one controller analyzes an action area of each of the information terminals, and
in obtaining the information on the result of the analysis, the at least one controller obtains information on a result of the analysis indicating the action area of each of the information terminals, and transmits the information on the result of the analysis through the at least one communications device to at least one of the information terminals.

5. The information providing apparatus according to claim 4, wherein
in analyzing the position information on the information terminals, the at least one controller analyzes the position information, on the information terminals stored in the at least one storage device, only for a predetermined time period in order to analyze the action area of each of the information terminals.

6. An information providing system, comprising:
a plurality of information terminals; and an information providing apparatus,
each of the information terminals transmitting position information on the information terminal to the information providing apparatus, and
the information providing apparatus analyzing the position information on each of the information terminals, obtaining information on a result of the analysis, and transmitting the information on the result of the analysis to at least one of the information terminals.

7. An information providing method executed by at least one of a plurality of information providing apparatus, the information providing method comprising:
receiving, from each of a plurality of information terminals, position information on the information terminal;
analyzing the received position information on each of the information terminals;
obtaining information on a result of the analysis; and
transmitting the information on the result of the analysis to at least one of the information terminals.
